(19) United States
(12) Patent Application Publication
(10) Pub. No.: US 2023/0387407 A1
(43) Pub. Date: Nov. 30, 2023

(54) POSITIVE ELECTRODE ACTIVE MATERIAL, ALL-SOLID-STATE BATTERY COMPRISING SAME, AND METHOD FOR MANUFACTURING SAME

(71) Applicant: KOREA ELECTRONICS TECHNOLOGY INSTITUTE, Seongnam-si (KR)

(72) Inventors: Woo Suk CHO, Seongnam-si (KR); Kyung Su KIM, Yongin-si (KR); Ji Sang YU, Seongnam-si (KR); Jun Ho SONG, Seongnam-si (KR); Keon Ho PARK, Seongnam-si (KR)

(21) Appl. No.: 18/364,737

(22) Filed: Aug. 3, 2023

Related U.S. Application Data
(63) Continuation of application No. PCT/KR2021/017591, filed on Nov. 26, 2021.

(30) Foreign Application Priority Data
Feb. 4, 2021 (KR) 10-2021-0015885

(51) Int. Cl. H01M 4/525; H01M 10/0525; H01M 10/0562; H01M 4/62; C01G 53/00

(52) U.S. Cl. CPC H01M 4/525; H01M 10/0525; H01M 10/0562; H01M 4/62; C01G 53/50; H01M 2004/028

(57) ABSTRACT

A positive electrode active material, an all-solid-state battery comprising same, and a method for manufacturing same are proposed. The positive electrode active material may include a lithium metal oxide in the form of single particles having a particle strength of 300 MPa to 1500 MPa and an average particle diameter of at most 10 μm. Since the positive electrode active material is in the form of single particles having a high particle strength of at least 300 MPa and a small average particle diameter of at most 10 μm as indicated above, cracks may not form or may be delayed even when pressure is applied during the manufacture of the positive electrode or structural stress is applied over the lifespan of the battery.

### CROSS REFERENCE TO RELATED APPLICATIONS

This is a continuation application of International Patent Application No. PCT/KR2021/017591, filed on Nov. 26, 2021, which claims priority to Korean patent application No. KR 10-2021-0015885 filed on Feb. 4, 2021, contents of each of which are incorporated herein by reference in their entireties.

### BACKGROUND

### Technical Field

The present disclosure relates to an all-solid-state battery, and more particularly, to a positive electrode active material having high particle strength and a small average particle size, an all-solid-state battery including the same, and a manufacturing method thereof.

### Description of Related Technology

An all-solid-state battery is one in which a flammable organic liquid electrolyte used in a lithium secondary battery is changed to a nonflammable or flame retardant solid electrolyte, and it is attracting attention in anticipation of improved safety and high energy density through the application of new electrode materials. The all-solid-state battery can apply the same positive electrode active material and negative electrode active material as those of a lithium secondary battery, but there is a difference in that a separator and an electrolyte are replaced with a solid electrolyte layer.

### SUMMARY

One aspect is a positive electrode active material having high discharge capacity, excellent rate characteristics, and long lifespan characteristics, an all-solid-state battery including the same, and a manufacturing method thereof.

Another aspect is a positive electrode active material having high particle strength and a small average particle size, an all-solid-state battery including the same, and a manufacturing method thereof.

Another aspect is a positive electrode active material for an all-solid-state battery, including a lithium metal oxide in the form of a single particle having a particle strength of 300 to 1500 MPa and an average particle size of 10 μm or less.

The lithium metal oxide may be represented by Chemical Formula below:

LiₓM_{y}O₂ [Chemical Formula]

(where M includes at least one selected from Co, Mn, Ni, Al, Fe, V, Zn, Cr, Ti, Ta, Mg, Mo, Zr, W, Sn, Hf, Nd, and Gd, 0<x≤1.5, and 0<y≤1).

The lithium metal oxide may be LiNiₐCo_{b}Mn_{c}O₂ (0.6≤a≤0.9, a+b+c=1).

The lithium metal oxide may have a particle strength of 500 MPa or more and an average particle size of 1 μm to 7 μm.

In addition, the present disclosure provides a method of manufacturing a positive electrode active material for an all-solid-state battery, the method including preparing a lithium metal oxide raw material by mixing a transition metal composite precursor and a lithium source followed by primary heat treatment; pulverizing the lithium metal oxide raw material; and producing a lithium metal oxide in the form of a single particle having a particle strength of 300 to 1500 MPa and an average particle size of 10 μm or less through secondary heat treatment for the pulverized lithium metal oxide raw material.

The transition metal composite precursor is a spherical transition metal composite hydroxide or transition metal composite carbonate prepared by a co-precipitation method.

The lithium metal oxide raw material is secondary particles having an average particle size of 10 μm or less in which primary particles of hundreds of nanometers are agglomerated.

The lithium metal oxide raw material in which the primary particles are agglomerated may be pulverized through a ball milling process.

The transition metal composite precursor may be NiₐCo_{b}Mn_{c}(OH)₂ or NiₐCo_{b}Mn_{c}O₂ (0.6≤a≤0.9, a+b+c=1), and the lithium metal oxide may be LiNiₐCo_{b}Mn_{c}O₂ (0.6≤a≤0.9, a+b+c=1).

In addition, the present disclosure provides a positive electrode for an all-solid-state battery including a solid electrolyte; a conductive material; and a positive electrode active material of a lithium metal oxide in the form of a single particle having a particle strength of 300 to 1500 MPa and an average particle size of 10 μm or less.

In addition, the present disclosure provides an all-solid-state battery including the above positive electrode; a solid electrolyte layer; and a negative electrode.

The positive electrode active material according to the present disclosure has a high particle strength and a small average particle size in the form of a single particle, so that it can provide high discharge capacity, excellent rate characteristics, and long lifespan characteristics.

That is, since the positive electrode active material according to the present disclosure has a high particle strength of 300 MPa or more in the form of single particles, cracks do not occur or are delayed even when pressure applied during manufacturing of the positive electrode or structural stress due to volume contraction and expansion during life progress is applied.

In addition, since the positive electrode active material according to the present disclosure has an average particle size of 10 μm or less in the form of single particles, the conduction (movement) time of lithium ions is short, thereby providing excellent rate characteristics and long lifespan characteristics.

### BRIEF DESCRIPTION OF THE DRAWINGS

FIG. 1 is a cross-sectional view showing an all-solid-state battery according to the present disclosure.

FIG. 2 is an enlarged view showing portion A of a positive electrode in FIG. 1.

FIG. 3 is a flow chart showing a method of manufacturing a positive electrode active material for an all-solid-state battery according to the present disclosure.

FIG. 4 is a view showing a change caused by stress acting on a positive electrode active material for an all-solid-state battery according to the prior art and the present disclosure.

FIG. 5 is a SEM photograph showing a positive electrode active material for an all-solid-state battery according to a comparative example.

FIG. 6 is a SEM photograph showing a positive electrode active material for an all-solid-state battery according to an embodiment.

FIG. 7 is a view showing a conduction process of lithium ions in a positive electrode active material for an all-solid-state battery according to a comparative example.

FIG. 8 is a view showing a conduction process of lithium ions in a positive electrode active material for an all-solid-state battery according to an embodiment.

FIG. 9 is a graph showing charge and discharge curves of an all-solid-state battery including a positive electrode active material according to a comparative example.

FIG. 10 is a graph showing charge and discharge curves of an all-solid-state battery including a positive electrode active material according to an embodiment.

FIG. 11 is a graph showing lifespan characteristics evaluation results of all-solid-state batteries according to a comparative example and an embodiment.

FIG. 12 is a SEM photograph showing a positive electrode active material according to a comparative example after lifespan characteristics evaluation of FIG. 11.

FIG. 13 is a SEM photograph showing a positive electrode active material according to an embodiment after lifespan characteristics evaluation of FIG. 11.

### DETAILED DESCRIPTION

In the all-solid-state battery, a positive electrode in which a positive electrode active material and a solid electrolyte are mixed in a certain ratio is implemented in contact with a solid electrolyte layer in order to form a smooth ion conduction channel in the positive electrode.

Since the lithium secondary battery uses a liquid electrolyte, the electrolyte penetrates smoothly into the particles of the positive electrode active material. Thus, in the lithium secondary battery, contact between the positive electrode active material and the electrolyte is evenly made on the surfaces and inside of the particles of the positive electrode active material to form a smooth ion conduction channel.

However, since the positive electrode of the all-solid-state battery forms an ion conduction channel by surface contact between the positive electrode active material and the solid electrolyte, the solid electrolyte cannot penetrate into the particles of the positive electrode active material. That is, since an ion conduction channel is formed between the positive electrode active material and the solid electrolyte only by particle surface contact, if the contact area between the positive electrode active material and the solid electrolyte is not sufficiently secured, it acts as resistance and the degree of capacity realization is poor.

In addition, since the solid electrolyte does not penetrate into the particle unlike the liquid electrolyte, depending on the particle size of the positive electrode active material, a drop in the ability of lithium ion diffusion (i.e., bulk conductivity) within the particle also acts as resistance.

In the following description, only parts necessary to understand embodiments of the present disclosure will be described, and other parts will not be described to avoid obscuring the subject matter of the present disclosure.

Terms used herein should not be construed as being limited to their usual or dictionary meanings. In view of the fact that the inventor can appropriately define the meanings of terms in order to describe his/her own invention in the best way, the terms should be interpreted as meanings consistent with the technical idea of the present disclosure. In addition, the following description and corresponding drawings merely relate to specific embodiments of the present disclosure and do not represent all the subject matter of the present disclosure. Therefore, it will be understood that there are various equivalents and modifications of the disclosed embodiments at the time of the present application.

Now, embodiments of the present disclosure will be described in detail with reference to the accompanying drawings.

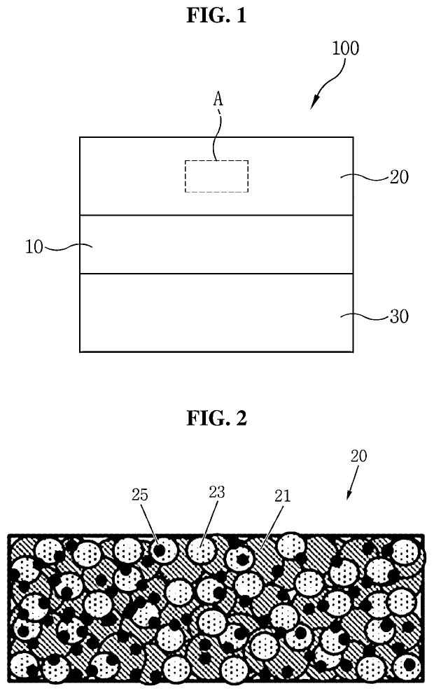

FIG. 1 is a cross-sectional view showing an all-solid-state battery according to the present disclosure. FIG. 2 is an enlarged view showing portion A of a positive electrode in FIG. 1.

Referring to FIG. 1, an all-solid-state battery 100 according to the present disclosure includes a solid electrolyte layer 10, and a positive electrode 20 and a negative electrode 30 formed to be in contact with both sides of the solid electrolyte layer 10.

The solid electrolyte layer 10 may include at least one of sulfide-based, oxide-based, and chloride-based solid electrolytes.

Here, the sulfide-based solid electrolyte may be LₐM_{b}P_{c}S_{d}Xₑ (where L is alkali metal, M includes at least one of B, Al, Ga, In, Si, Ge, Sn, Pb, As, Sb, Bi, Ti, V, Cr, Mn, Fe, Co, Ni, Cu, Y, Zr, Nb, Mo, Tc, Ru, Rh, Pd, Ag, Hf, Ta and W, X includes at least one of F, Cl, Br, I and O, 0≤a≤12, 0≤b≤6, 0≤c≤6, 0≤d≤12, and 0≤e≤9). Meanwhile, the sulfide-based solid electrolyte may be a plurality of crystalline solid electrolytes, a plurality of amorphous sulfide-based solid electrolytes, or a mixture thereof. For example, as the sulfide-based solid electrolyte, Li₆PS₅Cl(LPSCl), Li₁₀GeP₂Si₂(LGPS), Li₂S—P₂S₅(LPS) solid solution, and the like may be used.

As the oxide-based solid electrolyte, Li₃ₓLa_{2/3-x}TiO₃(LLTO), Li₇La₃Zr₂O₁₂(LLZO), and the like may be used.

In addition, as the chloride-based solid electrolyte, Li₃YCl₆, Li₃YBr₆, and the like may be used.

The positive electrode 20 includes a positive electrode active material 21, a solid electrolyte 23, and a conductive material 25. The positive electrode 20 may include a binder.

The positive electrode active material 21 is a material that allows intercalation and deintercalation of lithium ions, and includes lithium metal oxide used in lithium secondary batteries. The positive electrode active material 21 according to the present disclosure is a lithium metal oxide in the form of a single particle having a particle strength of 300 to 1500 MPa and an average particle size of 10 μm or less. Preferably, a lithium metal oxide having a particle strength of 500 MPa or more and an average particle size of 1 μm to 7 μm may be used as the positive electrode active material 21.

The positive electrode active material 21 according to the present disclosure includes a lithium metal oxide containing at least one of nickel (Ni), manganese (Mn), and cobalt (Co), and can be represented by Chemical Formula 1 below.

LiₓM_{y}O₂ [Chemical Formula 1]

(where M includes at least one selected from Co, Mn, Ni, Al, Fe, V, Zn, Cr, Ti, Ta, Mg, Mo, Zr, W, Sn, Hf, Nd, and Gd, 0<x≤1.5, and 0<y≤1).

For example, the positive electrode active material 21 may be a Ni-rich layered lithium metal compound with a small particle diameter including nickel (Ni), manganese (Mn), and cobalt (Co). This lithium metal oxide is represented by LiNiₐCo_{b}Mn_{c}O₂ (0.6≤a≤0.9, a+b+c=1), and is referred to as a Ni-rich NCM positive electrode active material.

The positive electrode active material 21 according to the present disclosure may be prepared based on a transition metal composite precursor. The transition metal composite precursor may be a spherical transition metal composite hydroxide or transition metal composite carbonate prepared by a co-precipitation method.

The transition metal composite hydroxide can be expressed as M_{y}(OH)₂ or M_{y}O₂. For example, when the transition metal composite precursor is NiₐCo_{b}Mn_{c}(OH)₂ or NiₐCo_{b}Mn_{c}O₂ (0.6≤a≤0.9, a+b+c=1), the lithium metal oxide prepared by the co-precipitation method is LiNiₐCo_{b}Mn_{c}O₂ (0.6≤a≤0.9, a+b+c=1).

The positive electrode active material 21 according to the present disclosure is a lithium metal oxide prepared by applying a transition metal composite precursor prepared by the co-precipitation method as described above, has an average particle size of 10 μm or less, and has a single particle form with no interface between particles therein, so that diffusion of lithium ions inside the particle occurs only through grain.

The positive electrode active material 21 according to the present disclosure has high particle strength of 300 MPa or more, and particle destruction does not occur even when the positive electrode 20 is highly filled (high composite density), so that there is no isolated particle (death area) due to particle destruction. As a result, in the positive electrode active material 21 according to the present disclosure, particle cracking of the positive electrode active material 21 due to life progression is suppressed, and a high capacity retention rate can be secured.

As such, since the positive electrode active material 21 according to the present disclosure has a high particle strength and a small average particle size in the form of a single particle, it can provide high discharge capacity, excellent rate characteristics, and long lifespan characteristics.

As the solid electrolyte 23, the solid electrolyte used in the solid electrolyte layer 10 may be used.

The conductive material 25 is not particularly limited as long as it is a conductive material used in a battery. For example, as the conductive material, conductive carbon such as graphene, carbon nanotube, Ketjen black, activated carbon, super-p carbon in a powder form, Denka in a rod form, or vapor grown carbon fiber (VGCF) may be used.

As the binder, a polymer compound such as a fluorine-based, diene-based, acryl-based, or silicone-based polymer may be used. For example, the binder may be nitrile butadiene rubber (NBR), polytetrafluoroethylene (PTFE), polyvinylidene fluoride (PVDF), carboxymethyl cellulose (CMC), styrene butadiene rubber (SBR), or polyimide.

In addition, the negative electrode 30 includes a negative electrode active material, a solid electrolyte, and a conductive material. The negative electrode 30 may include a binder.

The negative electrode active material may be at least one selected from the group consisting of lithium metal, lithium alloy, lithium metal composite oxide, lithium-containing titanium composite oxide (LTO), and combinations thereof.

The solid electrolyte, the conductive material, and the binder used in the positive electrode 20 may also be used in the negative electrode 30, so that a description thereof will be omitted.

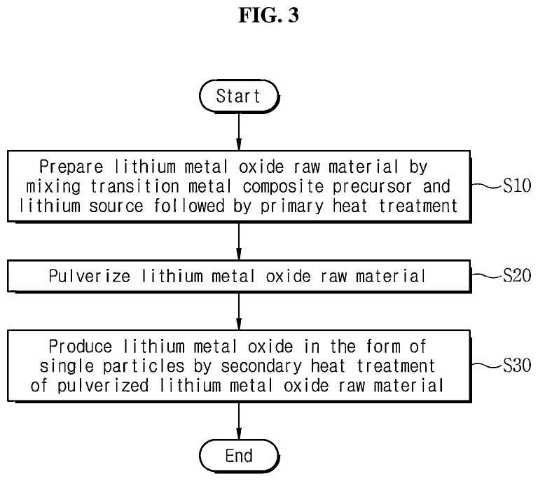

A method of manufacturing a positive electrode active material, as described above, for an all-solid-state battery according to the present disclosure will be described with reference to FIG. 3. FIG. 3 is a flow chart showing a method of manufacturing a positive electrode active material for an all-solid-state battery according to the present disclosure.

First, at step S10, a transition metal composite precursor and a lithium source are mixed, followed by primary heat treatment to prepare a lithium metal oxide raw material.

Here, the transition metal composite precursor may be a spherical transition metal composite hydroxide or transition metal composite carbonate prepared by a co-precipitation method.

The primary heat treatment may be performed on a mixture of the transition metal composite precursor and the lithium source at 800 to 900° C. in an oxygen atmosphere for 20 to 30 hours. The lithium metal oxide raw material prepared through the primary heat treatment is secondary particles having an average particle size of 10 μm or less in which primary particles of hundreds of nm are agglomerated.

Next, at step S20, the lithium metal oxide raw material is pulverized. That is, the lithium metal oxide raw material in which the primary particles are agglomerated may be pulverized by employing a ball milling process.

Then, at step S30, the pulverized lithium metal oxide raw material is subjected to secondary heat treatment to produce a lithium metal oxide in the form of a single particle having a particle strength of 300 to 1500 MPa and an average particle size of 10 μm or less.

The secondary heat treatment is performed in an oxygen atmosphere at a lower temperature than the first heat treatment and for a shorter time than the first heat treatment. That is, the secondary heat treatment may be performed at 600 to 700° C. in an oxygen atmosphere for 4 to 10 hours.

As described above, the positive electrode active material according to the present disclosure can be produced as a lithium metal oxide in the form of a single particle having a particle strength of 300 to 1500 MPa and an average particle size of 10 μm or less through primary heat treatment, pulverization, and secondary heat treatment.

The reason for using the positive electrode active material having a high particle strength and a small average particle size in the form of a single particle according to the present disclosure in an all-solid-state battery is as follows.

A typical Ni-rich NCM positive electrode active material is prepared by mixing a spherical transition metal composite precursor, prepared by a co-precipitation method, with a lithium source and heat-treating a mixture. In this case, the typical positive electrode active material maintains the same spherical shape and particle size as those of the transition metal composite precursor. In the typical positive electrode active material, primary particles of hundreds of nm are agglomerated to form spherical secondary particles.

As described above, a positive electrode of an all-solid-state battery includes a positive electrode active material, a solid electrolyte, and a conductive material, and may further include a binder for electrode sheet processing.

The movement of lithium ions in the positive electrode occurs only in the contact area between the positive electrode active material and the solid electrolyte. That is, it means that the movement of lithium ions is possible only on the contact surface between the positive electrode active material particles and the solid electrolyte particles. In addition, the solid electrolyte cannot penetrate into the positive electrode active material unlike the liquid electrolyte of the lithium secondary battery. Therefore, the movement of lithium ions is possible through the solid electrolyte in contact with the surface of the positive electrode active material particle.

In the all-solid-state battery, a crack phenomenon that particles of the positive electrode active material are destroyed, which occurs during cell manufacturing or battery use, causes serious performance degradation. Crack of the positive electrode active material include 1) crack of the positive electrode active material due to pressure (roll press, etc.) applied during electrode manufacturing, 2) crack due to structural stress as the lifespan progresses, and the like.

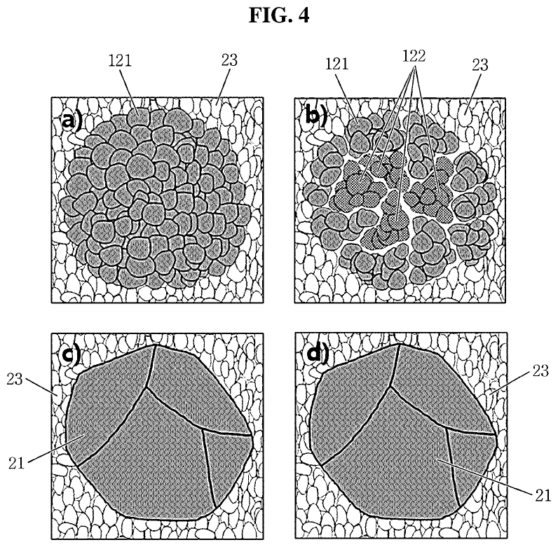

When cracks occur in the positive electrode active material particles due to complex causes as described above, the destroyed positive electrode active material 121 may have a death area 122, as shown in FIG. 4, which loses contact with the solid electrolyte 23 and exists in an isolated form inside the particle.

FIG. 4 is a view showing a change caused by stress acting on a positive electrode active material 21 or 121 for an all-solid-state battery according to the prior art and the present disclosure. Here, (a) and (b) show the positive electrode according to the prior art. Further, (c) and (d) show the positive electrode according to the present disclosure. In addition, (a) and (c) show the positive electrode before stress is applied, and (b) and (d) show the positive electrode after stress is applied.

Referring to FIG. 4, it can be seen that particles of the positive electrode active material 21 or 121 form a contact interface with the solid electrolyte 23.

As shown in (a) of FIG. 4, the conventional positive electrode active material 121 is a spherical secondary particle formed by aggregation of several hundreds of nanometers of primary particles.

Due to this, the conventional positive electrode active material 121 has weak particle strength. Thus, when stress acts on the positive electrode active material 121, cracks occur in the particles of the positive electrode active material 121 as shown in (b) of FIG. 4, which may cause the death area 122 to be formed.

When the death area 122 is formed within particles of the positive electrode active material 121, contact of the positive active material 121 particles with the solid electrolyte 23 is blocked in the death area 122. Thus, the movement of lithium ions for charging and discharging is impossible in the death area 122 of the positive electrode, so that deterioration of life characteristics such as capacity reduction occurs.

Therefore, considered in the present disclosure is making the positive electrode active material 21 to have high particle strength, thereby preventing cracks from occurring in the positive electrode active material 21 due to deterioration caused by physical pressure in a press process during positive electrode manufacturing and progress of battery life.

As described above, in the all-solid-state battery, due to its characteristics, the solid electrolyte 23 does not penetrate into the positive electrode active materials 21 or 121. This means that the movement of lithium ions is possible only through the particle surfaces of the positive electrode active material 21 or 121 and the solid electrolyte 23 in contact with the surface of the positive electrode active material 21 or 121. A lithium diffusion time coefficient (t) in the particle of the positive electrode active material 21 or 121 is expressed in Equation 1 below.

t=L²/D [Equation 1]
t: Diffusion time coefficient of lithium ions in particle
L: Diffusion distance (particle radius)
D: Diffusion coefficient

Therefore, in the all-solid-state battery, only diffusion (movement) from the surface of the positive electrode active material 21 or 121 to the center of the particle may be considered. For example, in the case of the positive electrode active materials having particle radii of L1 and L2 (L1>L2), it can be seen from Equation 1 that the positive electrode active material with a small particle radius of L2 has a shorter diffusion time of lithium ions than the positive electrode active material with a large particle radius of L1.

As such, since a small particle radius is advantageous for lithium ion diffusion within the particle, it is advantageous for improving electrochemical characteristics including rate characteristics of the battery.

Therefore, the present disclosure applies the positive electrode active material 21 having a high particle strength and a small average particle size to the all-solid-state battery, so that the positive electrode active material 21 does not cause cracks as shown in (c) and (d) of FIG. 4 even by the stress acting on it. As a result, the all-solid-state battery to which the positive electrode active material 21 according to the present disclosure is applied can provide high discharge capacity, excellent rate characteristics, and long lifespan characteristics.

### Embodiment and Comparative Example

In order to confirm the physical and electrochemical characteristics of the positive electrode active material for the all-solid-state battery according to the present disclosure, the positive electrode active materials according to an embodiment and a comparative example were prepared, respectively, and the all-solid-state battery including them were also prepared. A method for preparing the positive electrode active material according to the embodiment is only one example, and the present disclosure is not limited to that method.

A precursor of small particles of NiₐCo_{b}Mn_{c}(OH)₂ (a=0.82, b=0.12, c=0.06) with an average particle size of 4 μm was prepared using the co-precipitation method. By applying the NiₐCo_{b}Mn_{c}(OH)₂ precursor, positive electrode active materials having the same particle size and different particle shapes were prepared according to a comparative example and an embodiment.

### Comparative Example

The NiₐCo_{b}Mn_{c}(OH)₂ precursor having an average particle size of 4 μm was weighed and mixed with LiOH as a lithium source in a total amount of 10 g. In addition, an excessive amount of lithium was added so that the Li/transition metal ratio was 1.05. A positive electrode active material according to the comparative example was prepared by heat-treating a mixture of the NiₐCo_{b}Mn_{c}(OH)₂ precursor and LiOH at 800° C. in an oxygen atmosphere for 24 hours.

### Embodiment

Excepting that the heat treatment temperature was changed to 900° C., a primary heat treatment was performed under the same conditions as in the comparative example to prepare a lithium metal oxide raw material as a first fired product. Next, particle aggregation was pulverized from the lithium metal oxide raw material by a ball milling process. Then, a positive electrode active material according to the embodiment was prepared by subjecting the pulverized lithium metal oxide raw material to a secondary heat treatment at 675° C. in an oxygen atmosphere for 6 hours.

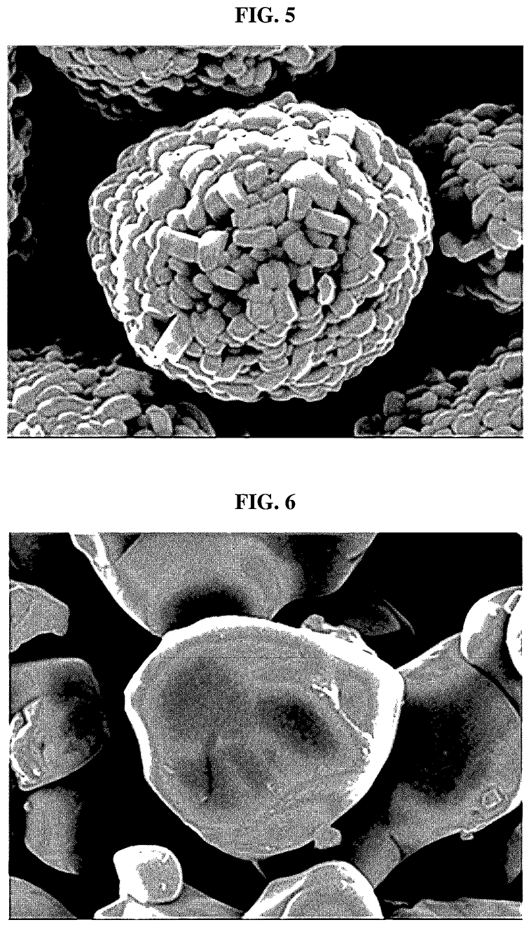

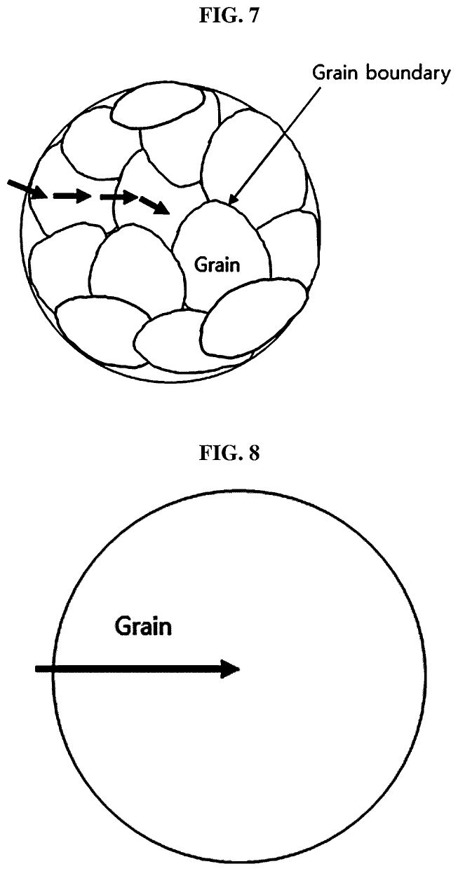

FIG. 5 is a SEM photograph showing a positive electrode active material for an all-solid-state battery according to a comparative example. FIG. 6 is a SEM photograph showing a positive electrode active material for an all-solid-state battery according to an embodiment.

Referring to FIGS. 5 and 6, the positive electrode active materials according to the comparative example and the embodiment are all spherical lithium metal oxides having an average particle diameter of about 5 μm.

In the positive electrode active material according to the comparative example, it can be seen that primary particles of several hundred nanometers are agglomerated to form a spherical secondary particle.

On the other hand, it can be seen that the positive electrode active material according to the embodiment has a single particle form in which primary particles do not exist.

The results of measuring the particle strength of the positive electrode active materials according to the comparative example and the embodiment are shown in Table 1 below.

TABLE 1

| Sample | Particle Strength (MPa) |
|---|---|
| Comparative Example | 114 |
| Embodiment | 1300 |

Referring to Table 1, it can be seen that since the positive electrode active material according to the embodiment has a single particle shape, it has a very high particle strength of 1300 MPa.

On the other hand, since the positive electrode active material according to the comparative example has a secondary particle form in which primary particles are agglomerated, a particle strength of 114 MPa, which is similar to that measured in a typical Ni-rich NCM positive electrode active material, was confirmed.

As such, it can be seen that the positive electrode active material according to the embodiment has a particle size of 5 μm level and high particle strength.

The conduction process of lithium ions in the positive electrode active material according to the comparative example and the embodiment will be described with reference to FIGS. 7 and 8. FIG. 7 is a view showing a conduction process of lithium ions in a positive electrode active material for an all-solid-state battery according to a comparative example. FIG. 8 is a view showing a conduction process of lithium ions in a positive electrode active material for an all-solid-state battery according to an embodiment.

It can be seen that the positive electrode active material according to the embodiment has a small particle size and high particle strength. In addition, since the positive electrode active material according to the embodiment has a single particle shape without secondary particles, it is possible to improve lithium ion conduction kinetics in an all-solid-state battery.

In the all-solid-state battery, as described above, the solid electrolyte cannot penetrate into the particles of the positive electrode active material. Therefore, the movement of lithium ions occurs from the surface of the positive electrode active material.

Since the positive electrode active material according to the comparative example has a particle form of a secondary particle in which primary particles are agglomerated, lithium ions are transferred while sequentially passing through grain of primary particle, grain boundary, next grain, next grain boundary, and the like as shown in FIG. 7. Therefore, the positive electrode active material according to the comparative example has a high resistance because the process of moving lithium ions is complicated.

On the other hand, since the positive electrode active material according to the embodiment has a single particle shape without grain boundary as shown in FIG. 8, lithium ions are transferred only through the grain. Therefore, the positive electrode active material according to the embodiment has a simple process of moving lithium ions, so that it has a relatively low resistance compared to the positive electrode active material according to the comparative example. As a result, the positive electrode active material according to the embodiment is expected to have excellent rate characteristics.

### All-Solid-State Battery

All-solid-state batteries were prepared by applying the positive electrode active materials according to the embodiment and the comparative example, and electrochemical characteristics were evaluated. The all-solid-state battery used a uniaxial pressure cell generally applied to the evaluation of sulfide-based solid electrolytes. Li₆PS₅Cl was used as the solid electrolyte and Super-P was used as the conductive material.

A composite was prepared by mixing the positive electrode active material, the solid electrolyte, and the conductive material in a weight ratio of 60:35:5, and 10 mg of the composite was used as the positive electrode. 100 mg of solid electrolyte was used. A Li—In alloy was used as the negative electrode.

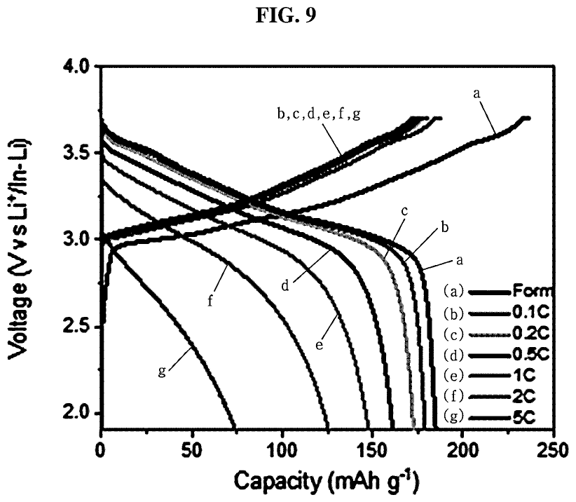

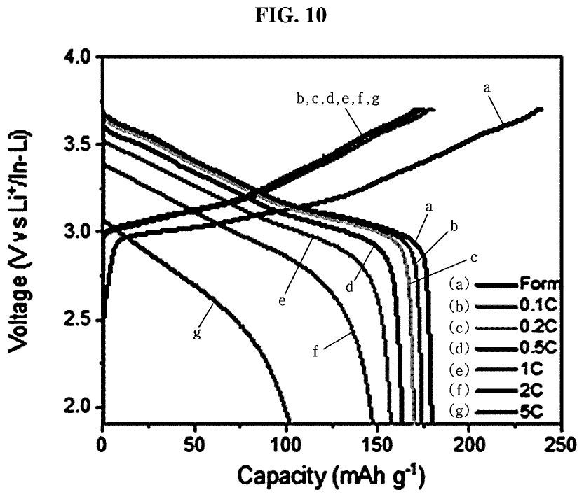

FIG. 9 is a graph showing charge and discharge curves of an all-solid-state battery including a positive electrode active material according to a comparative example. FIG. 10 is a graph showing charge and discharge curves of an all-solid-state battery including a positive electrode active material according to an embodiment. Here, FIGS. 9 and 10 show charge/discharge curves according to C-rate.

Table 2 shows the discharge capacity according to the C-rate of the all-solid-state battery according to the embodiment and the comparative example.

TABLE 2
Discharge Capacity (mAh/g)

| | | |
|---|---|---|
| C-rate | Comparative Example | Embodiment |

| | | | |
|---|---|---|---|
| 0.05 | C | 184.98 | 179.29 |
| 0.1 | C | 179.03 | 174.16 |
| 0.2 | C | 172.64 | 169.81 |
| 0.5 | C | 161.16 | 163.15 |
| 1 | C | 147.88 | 156.98 |
| 2 | C | 125.82 | 147.23 |
| 5 | C | 74.48 | 102.45 |

Referring to FIGS. 9, 10 and Table 2, it can be seen that the initial discharge capacity at 0.05 C was 185 mAh/g in the comparative example and 180 mAh/g in the embodiment, which was slightly higher in the comparative example, but at a similar level.

Next, the rate characteristics were evaluated, and it can be seen that the embodiment exhibits better rate characteristics than the comparative example. It is believed that this is because the positive electrode active material according to the embodiment has a single particle shape without grain boundaries, which is advantageous for the movement of lithium ions.

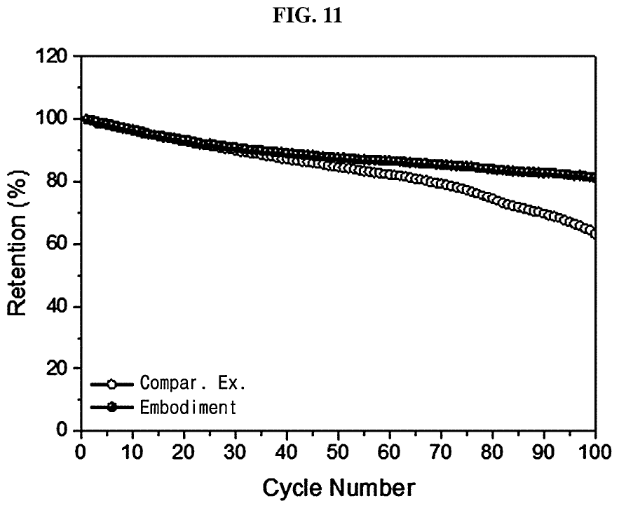

FIG. 11 is a graph showing lifespan characteristics evaluation results of all-solid-state batteries according to a comparative example and an embodiment.

Referring to FIG. 11, as a result of evaluating the lifespan characteristics after 100 charge/discharge cycles, the lifespan retention rate was 81% in the embodiment and 63% in the comparative example, indicating that the lifespan degradation was serious in the comparative example.

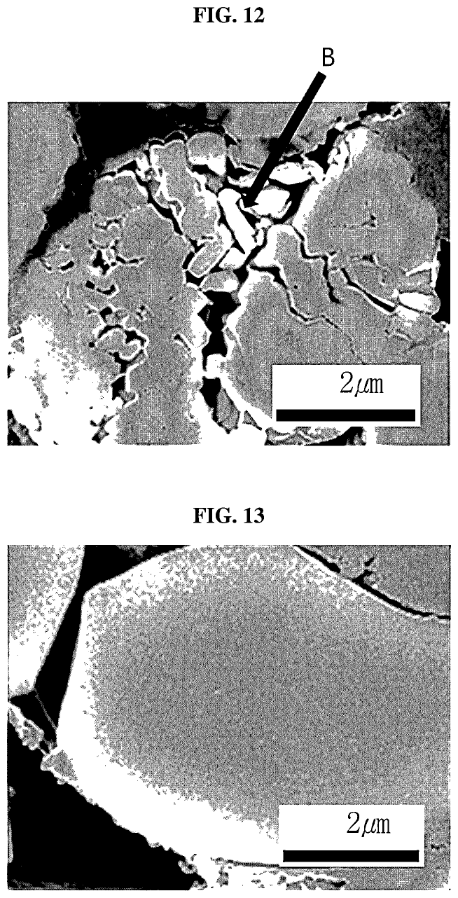

In order to determine the cause of lifespan degradation of the all-solid-state batteries according to the embodiment and the comparative example, the positive electrodes were recovered from the all-solid-state batteries whose lifespan characteristics were evaluated after 100 charge/discharge cycles. The recovered positive electrodes were subjected to cross-section processing, and SEM pictures were taken as shown in FIGS. 12 and 13. FIG. 12 is a SEM photograph showing a positive electrode active material according to a comparative example after lifespan characteristics evaluation of FIG. 11. FIG. 13 is a SEM photograph showing a positive electrode active material according to an embodiment after lifespan characteristics evaluation of FIG. 11.

Referring to FIG. 12, it can be seen that cracks occurred in the positive electrode active material particles according to the comparative example, resulting in a death area (B) without contact with the solid electrolyte.

On the other hand, it can be seen that the positive electrode according to the embodiment maintains the shape of the positive electrode active material particles well without cracking. That is, since the positive electrode active material according to the embodiment has high particle strength, cracks do not occur in the positive electrode active material particles.

Meanwhile, the embodiments disclosed in this specification and drawings are only presented as specific examples to aid understanding, and are not intended to limit the scope of the present disclosure. In addition to the embodiments disclosed herein, it is obvious to those skilled in the art that other modifications based on the technical idea of the present disclosure can be implemented.

What is claimed is:

1. A positive electrode active material for an all-solid-state battery, comprising a lithium metal oxide in the form of a single particle having a particle strength of 300 MPa to 1500 MPa and an average particle size of 10 μm or less.

2. The positive electrode active material of claim 1, wherein the lithium metal oxide is represented by Chemical Formula below:
LiₓM_{y}O₂ [Chemical Formula]
(where M includes at least one selected from Co, Mn, Ni, Al, Fe, V, Zn, Cr, Ti, Ta, Mg, Mo, Zr, W, Sn, Hf, Nd, and Gd, 0<x≤1.5, and 0<y≤1).

3. The positive electrode active material of claim 2, wherein the lithium metal oxide is LiNiₐCo_{b}Mn_{c}O₂ (0.6≤a≤0.9, a+b+c=1).

4. The positive electrode active material of claim 3, wherein the lithium metal oxide has a particle strength of 500 MPa or more and an average particle size of 1 μm to 7 μm.

5. A method of manufacturing a positive electrode active material for an all-solid-state battery, the method comprising:
preparing a lithium metal oxide raw material by mixing a transition metal composite precursor and a lithium source followed by primary heat treatment;
pulverizing the lithium metal oxide raw material; and
producing a lithium metal oxide in the form of a single particle having a particle strength of 300 MPa to 1500 MPa and an average particle size of 10 μm or less through secondary heat treatment for the pulverized lithium metal oxide raw material.

6. The method of claim 5, wherein the transition metal composite precursor is a spherical transition metal composite hydroxide or transition metal composite carbonate prepared by a co-precipitation method.

7. The method of claim 6, wherein the lithium metal oxide raw material is secondary particles having an average particle size of 10 μm or less in which primary particles of hundreds of nanometers are agglomerated.

8. The method of claim 7, wherein the lithium metal oxide raw material in which the primary particles are agglomerated is pulverized through a ball milling process.

9. The method of claim 6, wherein the lithium metal oxide is represented by Chemical Formula below:
LiₓM_{y}O₂ [Chemical Formula]
(where M includes at least one selected from Co, Mn, Ni, Al, Fe, V, Zn, Cr, Ti, Ta, Mg, Mo, Zr, W, Sn, Hf, Nd, and Gd, 0<x≤1.5, and 0<y≤1).

10. The method of claim 9, wherein the transition metal composite precursor is NiₐCo_{b}Mn_{c}(OH)₂ or NiₐCo_{b}Mn_{c}O₂ (0.6≤a≤0.9, a+b+c=1), and the lithium metal oxide is LiNiₐCo_{b}Mn_{c}O₂ (0.6≤a≤0.9, a+b+c=1).

11. The method of claim 10, wherein the lithium metal oxide has a particle strength of 500 MPa or more and an average particle size of 1 μm to 7 μm.

12. A positive electrode for an all-solid-state battery, comprising:
a solid electrolyte;
a conductive material; and
a positive electrode active material of a lithium metal oxide in the form of a single particle having a particle strength of 300 MPa to 1500 MPa and an average particle size of 10 μm or less.

13. An all-solid-state battery comprising:
a positive electrode;
a solid electrolyte layer; and
a negative electrode,
the positive electrode including:
a solid electrolyte;
a conductive material; and
a positive electrode active material of a lithium metal oxide in the form of a single particle having a particle strength of 300 MPa to 1500 MPa and an average particle size of 10 μm or less.
